(19) United States
(12) Patent Application Publication
(10) Pub. No.: US 2013/0052294 A1
(43) Pub. Date: Feb. 28, 2013

(54) MOLDING TOOL WITH A THREE DIMENSIONAL SURFACE RELIEF PATTERN AND METHOD OF MAKING THE SAME

(71) Applicants: Shaupoh Wang, Taichung City (TW); Ray Long Tsai, Taichung City (TW); Tung Chuan Chen, Taichung City (TW); Pei Shan Hsieh, Taichung City (TW); Hui Mei Chang, Taichung City (TW); Shih Tsung Chang, Taichung City (TW)

(72) Inventors: Shaupoh Wang, Taichung City (TW); Ray Long Tsai, Taichung City (TW); Tung Chuan Chen, Taichung City (TW); Pei Shan Hsieh, Taichung City (TW); Hui Mei Chang, Taichung City (TW); Shih Tsung Chang, Taichung City (TW)

(73) Assignee: TAIWAN GREEN POINT ENTERPRISES CO., LTD., Taichung City (TW)

(21) Appl. No.: 13/519,311

(22) PCT Filed: Mar. 30, 2011
(86) PCT No.: PCT/US11/30617

§ 371 Date: Nov. 12, 2012

(51) Int. Cl. C25D 1/10; B29C 59/02

(52) U.S. Cl. 425/385; 205/70

(57) ABSTRACT

A method of making a molding tool includes: preparing an imprinting master having a surface relief pattern; applying a curable material on a flexible film; embossing the curable material on the flexible film using the imprinting master so as to transfer the surface relief pattern to the curable material; curing the embossed curable material so as to form a patterned-and-cured material; attaching and conforming the flexible film to a non-planar surface of a model; forming a thin metal film over the patterned-and-cured material; electroforming a metal layer over the thin metal film so as to form a molding tool of the metal layer; and removing the molding tool from the thin metal film.

### BACKGROUND

1. Field

The invention relates to a molding tool with a three dimensional surface relief pattern and a method of making the same.

2. Description of the Related Art

In recent years, many molded articles, such as cosmetic bottles, cellular phone housing shells, housing shells of portable electronic devices, etc., are desirable to be formed with hologram patterns or light diffraction surface relief patterns (or other microstructure patterns) and/or logos on the outer surface thereof so as to attract the attention of potential customers.

U.S. Pat. No. 5,071,597 discloses a method of mass producing molded articles having a hologram or microstructure pattern formed on a non-planar surface thereof. The method includes the steps of: preparing a photosensitive plate including a substrate and a photoresist material formed on the substrate; optically forming a surface relief hologram or pattern in the photoresist material; forming a metal master that conforms to the shape of the surface relief pattern by electrodeposition; hot embossing a flexible film using the metal master so as to transfer the surface relief pattern to the flexible film; forming a model of the article to be molded; attaching the patterned flexible film to a non-planar surface of the model; forming a thin metal film over the patterned flexible film; electroforming a metal layer over the thin metal film on the patterned flexible film on the model so as to form a master mold of the metal layer having the surface relief pattern; removing the model and the flexible film from the master mold; attaching the master mold to a machined backing plate for strength; positioning the backed master mold with a plug or other element to form a mold cavity; injecting molten plastic material into the mold cavity to make a molded article; and metalizing the surface relief pattern on the molded article.

Since the surface relief pattern is directly formed in the flexible film, there arise problems that the former tends to be deformed when the flexible film is softened upon attachment to the model and can be seriously damaged when the flexible film is stretched or shrunk, and the greater the extent of stretching or shrinking, the greater the damage to the surface relief pattern will be. As a consequence, the flexible film can only be attached to a planar surface or a non-planar surface that is free of round corners, such as a cylindrical surface or a slightly tapered truncated-conical surface, so that the flexible film will not undergo stretching or shrinking in order to avoid damage to the surface relief pattern. Hence, the method of the prior art is disadvantageous in that the surface of the article to be formed with the surface relief pattern is limited to one that is planar or cylindrical.

The whole disclosure of U.S. Pat. No. 5,071,597 is incorporated herein by reference.

### SUMMARY

The object of the present invention is to provide a molding tool with a three dimensional surface relief pattern and a method of making the same that can overcome the aforesaid problems that the surface relief pattern tends to be deformed of damaged due to softening, stretching and shrinking and that is capable of forming a surface relief pattern passing over round corners of a non-planar surface of a molded article.

According to one aspect of the present invention, there is provided a method of making a molding tool with a three dimensional surface relief pattern. The method comprises: preparing an imprinting master having a surface relief pattern; applying a curable material on a flexible film; embossing the curable material on the flexible film using the imprinting master so as to transfer the surface relief pattern to the curable material; curing the embossed curable material on the flexible film so as to form on the flexible film a patterned-and-cured material having the surface relief pattern; attaching and conforming the flexible film to a non-planar surface of a model such that the patterned-and-cured material faces outwardly; forming a thin metal film over the patterned-and-cured material; electroforming a metal layer over the thin metal film so as to form on the thin metal film a molding tool of the metal layer having the surface relief pattern; and removing the molding tool from the thin metal film.

According to another aspect of the present invention, there is provided a molding tool having a shell body with an inner wall that is formed with a three dimensional surface relief pattern and that has a main side and a plurality of lateral sides, each of which cooperates with the main side to define a round corner therebetween. The three dimensional surface relief pattern exhibits a hologram effect, extends from the main side to each of the lateral sides, and passes over a respective one of the round corners defined by the main side and the lateral sides.

### BRIEF DESCRIPTION OF THE DRAWINGS

In drawings which illustrate embodiments of the invention,

FIG. 1 is a flow chart of the first preferred embodiment of a method of making a molding tool with a three dimensional surface relief pattern according to this invention;

FIGS. 2A to 2K are schematic views to illustrate consecutive steps of the first preferred embodiment;

FIGS. 3A to 3C are photo images of a molding tool made by the first preferred embodiment of the method of this invention;

FIG. 4 is a photo image of a plastic shell made by injection molding using a molding tool formed by the first preferred embodiment of the method of this invention; and

FIGS. 5A to 5F are schematic views to illustrate consecutive steps of forming an imprinting master of the second preferred embodiment of the method of this invention.

### DETAILED DESCRIPTION OF THE PREFERRED EMBODIMENTS

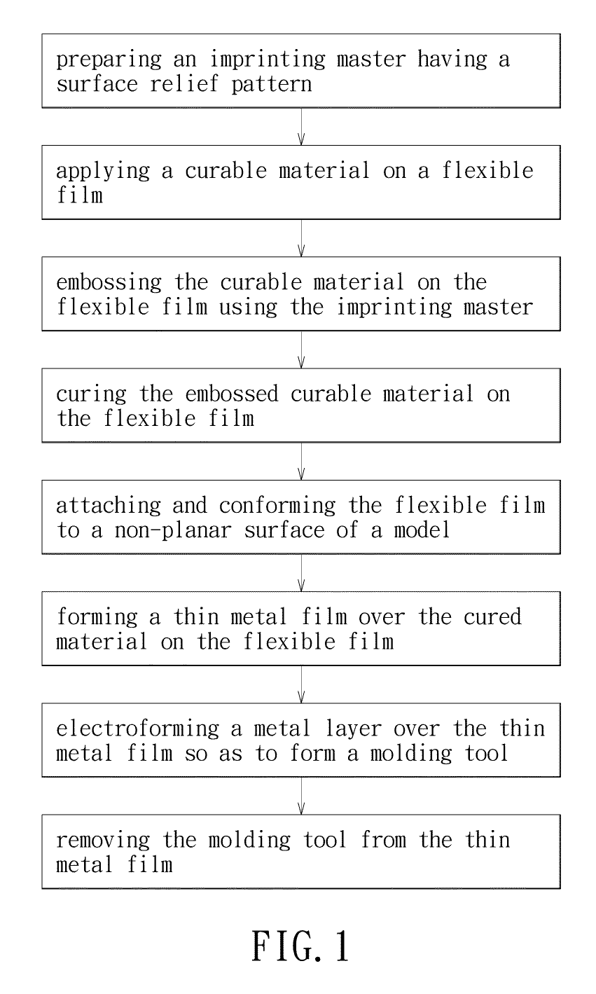

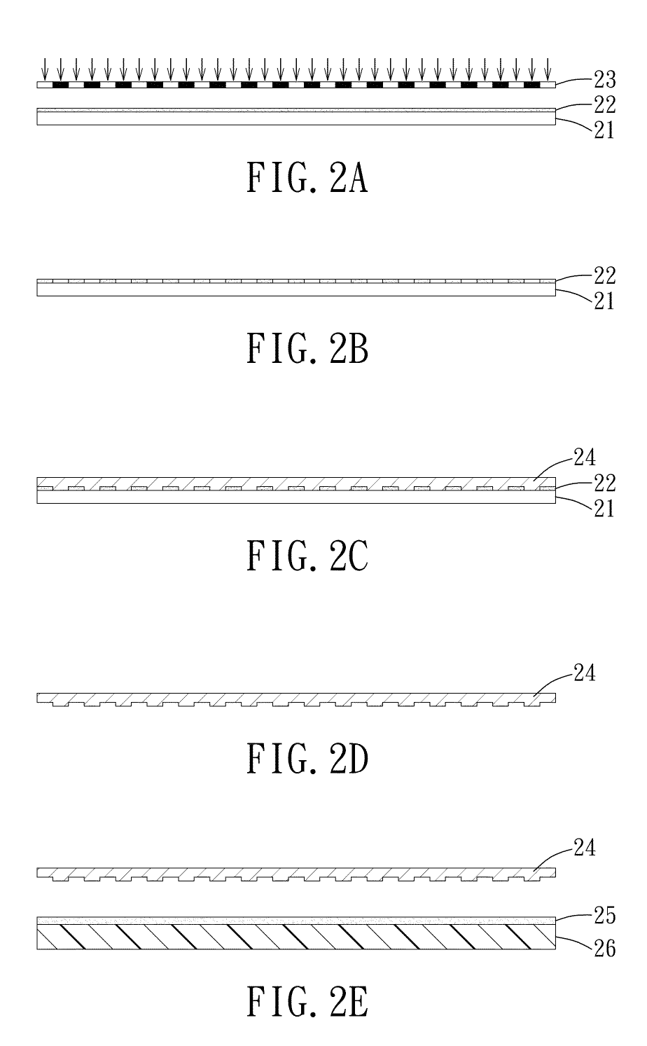

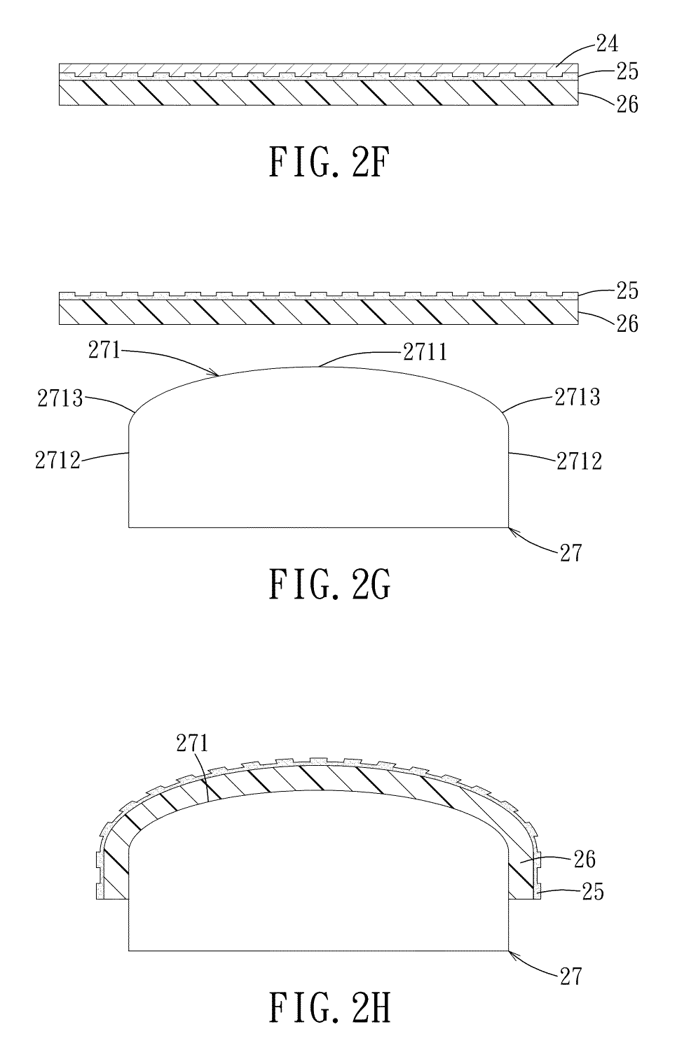

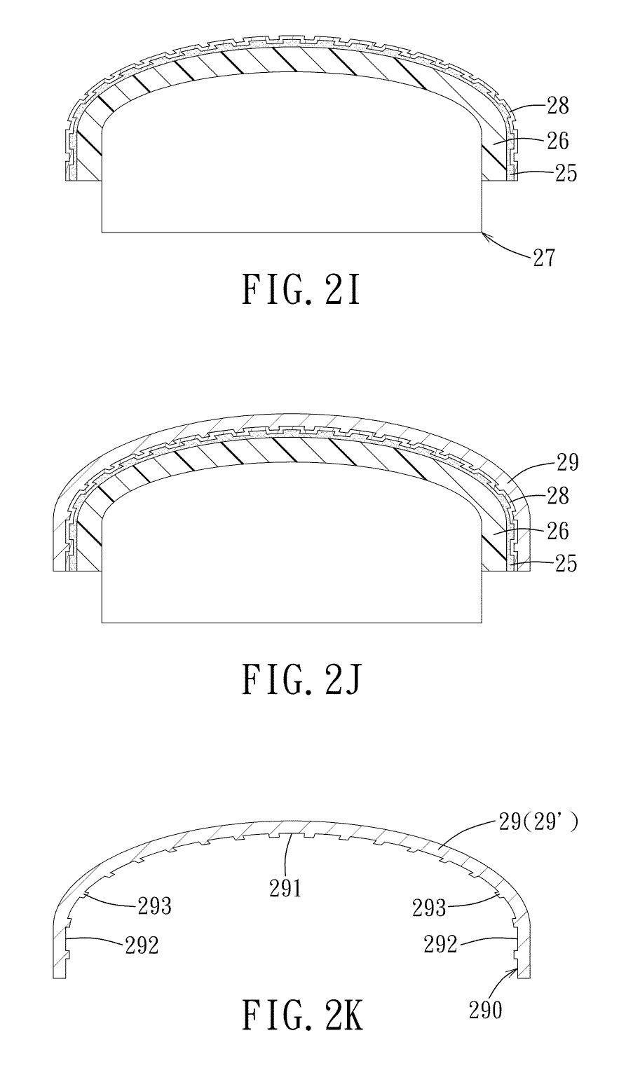

FIGS. 1 and 2A-2K illustrate consecutive steps of the first preferred embodiment of a method of making a molding tool 29 with a three dimensional surface relief pattern (such as a hologram pattern or a light diffractive surface relief pattern which includes a pattern of microstructures, each microstructure being defined herein as having a size of micrometer or nanometer) for production of a three dimensional molded article (not shown), such as a cellular phone housing shell, having the three dimensional surface relief pattern.

The method of the first preferred embodiment comprises: applying a photoresist material 22 to a substrate 21 of a metal plate (see FIG. 2A); forming a surface relief pattern in the photoresist material 22 using a photomask 23 through photolithography techniques (see FIGS. 2A and 28); electroforming a metal film over the patterned photoresist material 22 so as to form an imprinting master 24 having the surface relief pattern on the patterned photoresist material 22 (see FIG. 2C); removing the imprinting master 24 from the patterned photoresist material 22 (see FIG. 2D); applying a curable material 25 on a flexible film 26 (see FIG. 2E); hot embossing the curable material 25 on the flexible film 26 using the imprinting master 24 so as to transfer the surface relief pattern to the curable material 25 (see FIG. 2F); removing the flexible film 26 together with the embossed curable material 25 from the imprinting master 24 (see FIG. 2G); curing the embossed curable material 25 on the flexible film 26 so as to form on the flexible film 26 a patterned-and-cured material 25 having the surface relief pattern; softening the flexible film 26 by heating and stretching the flexible film 26; attaching and conforming the flexible film 26 to a non-planar surface 271 of a model 27 of the article (not shown) to be molded such that the patterned-and-cured material 25 faces outwardly (see FIG. 2H), the model being made of metal; forming a thin metal film 28 over the patterned-and-cured material 25 (see FIG. 2I) through surface metallization techniques (such as vapor metallization or sputtering techniques) for subsequent processing; electroforming a metal layer over the thin metal film 28 on the patterned-and-cured material 25 on the flexible film 26 on the model 27 so as to form on the thin metal film 28 a molding tool 29 of the metal layer having the surface relief pattern (see FIG. 2J); and removing the molding tool 29 from the thin metal film 28 (see FIG. 2K).

It is noted that electroforming is a well known and developed technique in the art. Hence, details of the process of electroforming of the imprinting master 24 and the molding tool 29 of the metal layer will not be described herein for the sake of brevity.

Preferably, the curable material is a photo sensitive material, and is more preferably a UV curable glue.

The flexible film 26 preferably has a thickness of less than 3 mm and is preferably made from a material selected from polycarbonate, poly (methyl methacrylate), and poly(ethylene terephthalate).

Referring to FIGS. 2G and 2H, in the preferred embodiment, the non-planar surface 271 of the model 27 has a main side 2711 and a plurality of lateral sides 2712, each of which cooperates with the main side 2711 to form a round corner 2713 therebetween. The flexible film 26 wraps around the round corners 2713 defined by the main side 2711 and the lateral sides 2712 when attached to the non-planar surface 271 of the model 27.

Referring to FIG. 2K, in the preferred embodiment, the molding tool 29 thus formed has a shell body 29′ with an inner wall 290 that is formed with the three dimensional surface relief pattern and that has a main side 291 and a plurality of lateral sides 292, each of which cooperates with the main side 291 to define a round corner 293 therebetween. The three dimensional surface relief pattern exhibits a strong light diffractive effect (or a hologram effect), extends from the main side 291 to each of the lateral sides 292, and passes over the round corners 293 defined by the main side 291 and the lateral sides 292.

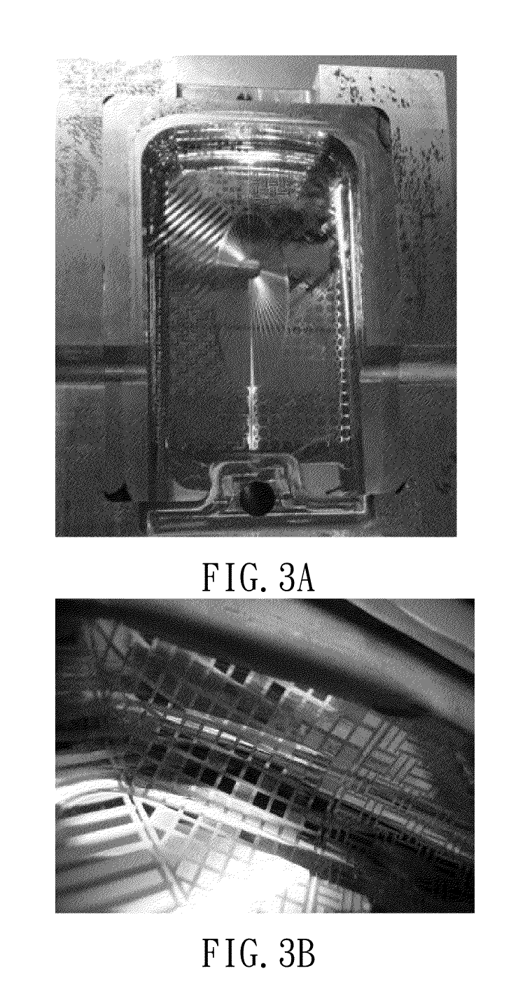

FIGS. 3A to 3C are photo images of the molding tool 29 formed with the three dimensional surface relief pattern according to the method of this invention.

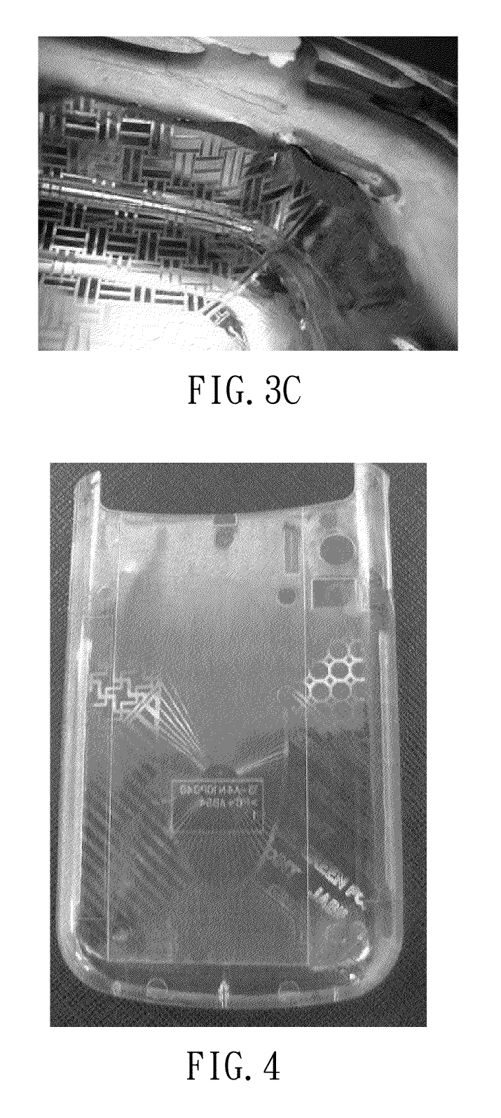

FIG. 4 shows a photo image of a transparent plastic shell made by conventional injection molding techniques using the molding tool 29 formed by the method of this invention. The three dimensional surface relief pattern is transferred from the molding tool 29 to the plastic shell.

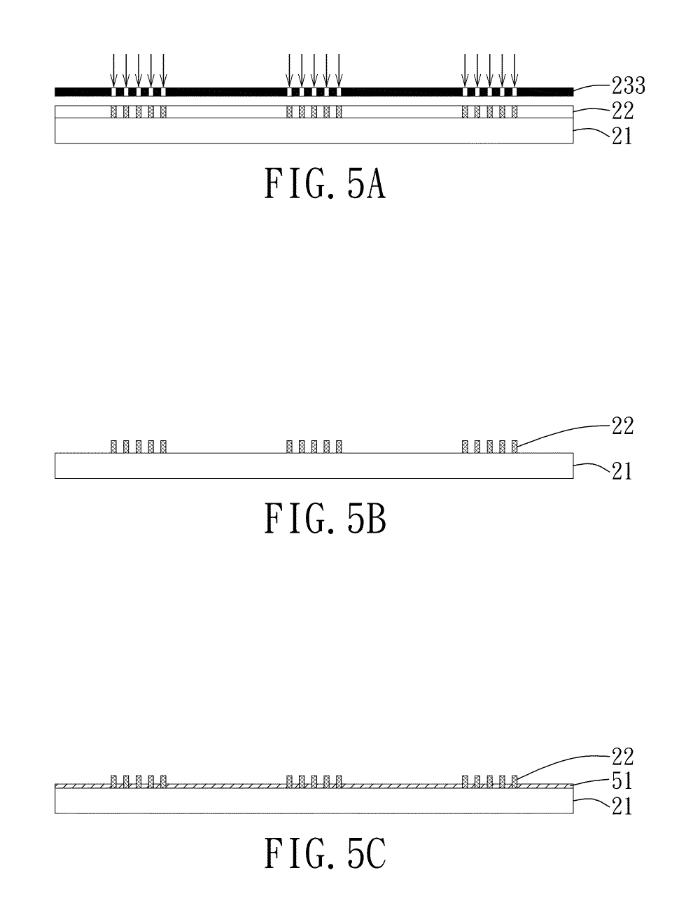

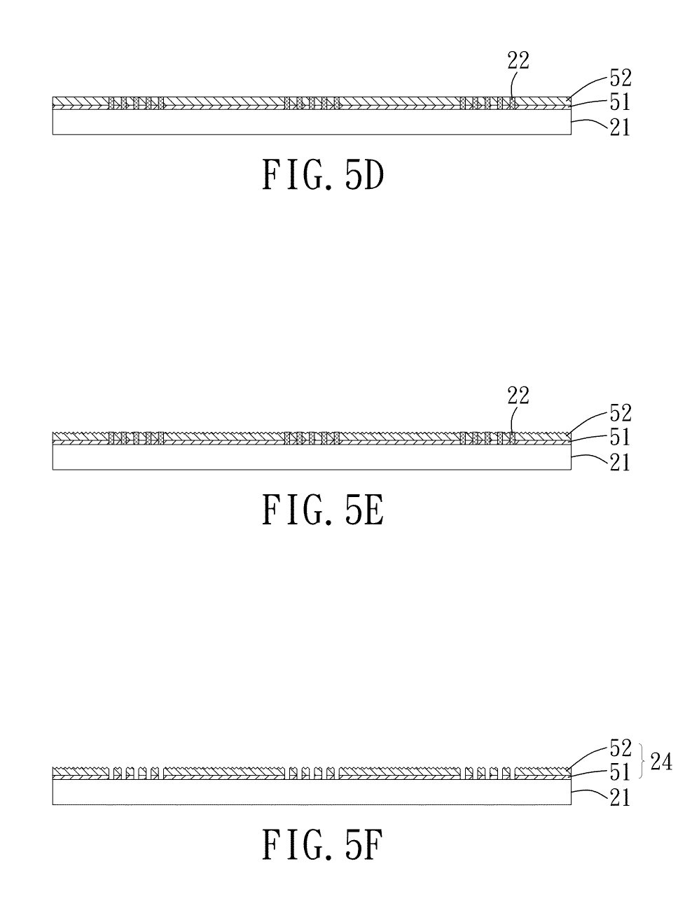

FIGS. 5A to 5F illustrate consecutive steps of forming the imprinting master of the second preferred embodiment of the method of this invention. The second preferred embodiment differs from the previous embodiment in that the imprinting master 24 employed in the second preferred has two different surface relief patterns and that preparation of the imprinting master 24 is performed by the following steps: applying a photoresist material 22 to a surface of a substrate 21 of a metal plate (see FIG. 5A); forming a first surface relief pattern in the photoresist material 22 using a photomask 233 through photolithography techniques (see FIGS. 5A and 5B); forming a thin metal film of copper 51 on the surface of the substrate 21 through electroplating techniques (see FIG. 5C) for subsequent electro forming; electroforming a metal layer 52 of nickel or copper on the thin metal film 51 (see FIG. 5D), the metal layer 52 having an upper surface that is substantially flush with an upper surface of the photoresist material 22; forming a second surface relief pattern (which is in the form of a hair-line-like pattern) on the metal layer 52 (see FIG. 5E) by polishing the metal later 52 using a hair-line surface polishing machine (not shown); and removing the photoresist material 22 from the substrate 21 so as to form the imprinting master 24 having the first and second surface relief patterns thereon (FIG. 5F). Note that the aforesaid step of forming the thin metal film 51 on the substrate 21 can be omitted and that the metal layer 52 can be directly formed on the substrate 21 for subsequent processing.

By forming the surface relief pattern(s) in the curable material 25 on the flexible film 26 (see FIG. 2F) according to the method of this invention, the aforesaid drawbacks regarding deformation and damage to the surface art can be eliminated, and the molding tool 29 thus formed can produce a molded article having a three dimensional surface relief pattern passing over round corners of the molded article.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

All elements, parts and steps described herein are preferably included. It is to be understood that any of these elements, parts and steps may be replaced by other elements, parts and steps or deleted altogether as will be obvious to those skilled in the art.

Broadly, this writing discloses a method of making a molding tool that includes: preparing an imprinting master having a surface relief pattern; applying a curable material on a flexible film; embossing the curable material on the flexible film using the imprinting master so as to transfer the surface relief pattern to the curable material; curing the embossed curable material so as to form a patterned-and-cured material; attaching and conforming the flexible film to a non-planar surface of a model; forming a thin metal film over the patterned-and-cured material; electroforming a metal layer over the thin metal film so as to form a molding tool of the metal layer; and removing the molding tool from the thin metal film.

### Concepts

This writing has disclosed at least the following concepts.

Concept 1. A method of making a molding tool with a three dimensional surface relief pattern, the method comprising;

preparing an imprinting master having a surface relief pattern;

applying a curable material on a flexible film;

embossing the curable material on the flexible film using the imprinting master so as to transfer the surface relief pattern to the curable material;

curing the embossed curable material on the flexible film so as to form on the flexible film a patterned-and-cured material having the surface relief pattern;

attaching and conforming the flexible film to a non-planar surface of a model such that the patterned-and-cured material faces outwardly;

forming a thin metal film over the patterned-and-cured material;

electroforming a metal layer over the thin metal film so as to form on the thin metal film a molding tool of the metal layer having the surface relief pattern, and removing the molding tool from the thin metal film.

Concept 2. The method of Concept 1, wherein the flexible film is softened and stretched when attaching to the non-planar surface of the model.

Concept 3. The method of Concept 1, wherein the curable material is a UV curable glue.

Concept 4. The method of Concept 1, wherein the flexible film is made from a material selected from polycarbonate, poly (methyl methacrylate), and poly (ethylene terephthalate)

Concept 5. The method of Concept 1, wherein the non-planar surface of the model has a main side and a plurality of lateral sides, each of which cooperates with the main side to form a round corner therebetween, the flexible film wrapping around the round corners defined by the main side and the lateral sides when attached to the non-planar surface of the model.

Concept 6. The method of Concept 1, wherein preparation of the imprinting master is conducted by applying a photoresist material to a substrate, forming the surface relief pattern in the photoresist material using photolithography techniques, electroforming a metal film over the patterned photoresist material so as to form the imprinting master, and removing the imprinting master from the patterned photoresist material.

Concept 7. The method of Concept 1, wherein preparation of the imprinting master is conducted by applying a photoresist material to a substrate, forming a first surface relief pattern in the photoresist material using photolithography techniques, electroforming a metal layer on the substrate, forming a second surface relief pattern on the metal layer by polishing the metal layer, and removing the photoresist material from the substrate so as to form the imprinting master having the first and second surface relief patterns thereon.

Concept 8. The method of Concept 7, wherein preparation of the imprinting master further includes forming a thin metal film on the substrate for subsequent electroforming of the metal layer.

Concept 9. A molding tool having a shell body with an inner wall that is formed with a three dimensional surface relief pattern and that has a main side and a plurality of lateral sides, each of which cooperates with the main side to define a round corner therebetween, the three dimensional surface relief pattern passing over the round corners defined by the main side and the lateral sides, the molding tool being made by the method defined in Concept 1.

Concept 10. A molding tool having a shell body with an inner wall that is formed with a three dimensional surface relief pattern and that has a main side and a plurality of lateral sides, each of which cooperates with said main side to define a round corner therebetween, said three dimensional surface relief pattern exhibiting a hologram effect, extending from said main side to each of said lateral sides, and passing over said round corners defined by said main side and said lateral sides.

What is claimed is:

1. A method of making a molding tool with a three dimensional surface relief pattern, the method comprising;
preparing an imprinting master having a surface relief pattern;
applying a curable material on a flexible film;
embossing the curable material on the flexible film using the imprinting master so as to transfer the surface relief pattern to the curable material;
curing the embossed curable material on the flexible film so as to form on the flexible film a patterned-and-cured material having the surface relief pattern;
attaching and conforming the flexible film to a non-planar surface of a model such that the patterned-and-cured material faces outwardly;
forming a thin metal film over the patterned-and-cured material;
electroforming a metal layer over the thin metal film so as to form on the thin metal film a molding tool of the metal layer having the surface relief pattern, and removing the molding tool from the thin metal film.

2. The method of claim 1, wherein the flexible film is softened and stretched when attaching to the non-planar surface of the model.

3. The method of claim 1, wherein the curable material is a UV curable glue.

4. The method of claim 1, wherein the flexible film is made from a material selected from polycarbonate, poly (methyl methacrylate), and poly (ethylene terephthalate)

5. The method of claim 1, wherein the non-planar surface of the model has a main side and a plurality of lateral sides, each of which cooperates with the main side to form a round corner therebetween, the flexible film wrapping around the round corners defined by the main side and the lateral sides when attached to the non-planar surface of the model.

6. The method of claim 1, wherein preparation of the imprinting master is conducted by applying a photoresist material to a substrate, forming the surface relief pattern in the photoresist material using photolithography techniques, electroforming a metal film over the patterned photoresist material so as to form the imprinting master, and removing the imprinting master from the patterned photoresist material.

7. The method of claim 1, wherein preparation of the imprinting master is conducted by applying a photoresist material to a substrate, forming a first surface relief pattern in the photoresist material using photolithography techniques, electroforming a metal layer on the substrate, forming a second surface relief pattern on the metal layer by polishing the metal layer, and removing the photoresist material from the substrate so as to form the imprinting master having the first and second surface relief patterns thereon.

8. The method of claim 7, wherein preparation of the imprinting master further includes forming a thin metal film on the substrate for subsequent electroforming of the metal layer.

9. A molding tool having a shell body with an inner wall that is formed with a three dimensional surface relief pattern and that has a main side and a plurality of lateral sides, each of which cooperates with the main side to define a round corner therebetween, the three dimensional surface relief pattern passing over the round corners defined by the main side and the lateral sides, the molding tool being made by the method defined in claim 1.

10. A molding tool having a shell body with an inner wall that is formed with a three dimensional surface relief pattern and that has a main side and a plurality of lateral sides, each of which cooperates with said main side to define a round corner therebetween, said three dimensional surface relief pattern exhibiting a hologram effect, extending from said main side to each of said lateral sides, and passing over said round corners defined by said main side and said lateral sides.
